(19) United States
(12) Patent Application Publication
(10) Pub. No.: US 2023/0387461 A1
(43) Pub. Date: Nov. 30, 2023

(54) WETTABILITY ADDITIVES FOR LITHIUM ION BATTERIES

(71) Applicant: Rivian IP Holdings, LLC, Irvine, CA (US)

(72) Inventors: Liyuan Sun, Palo Alto, CA (US); Judith Alvarado Kim, San Leandro, CA (US); Soo Kim, Fremont, CA (US); Tae Kyoung Kim, Albany, CA (US); Ki Tae Park, Santa Clara, CA (US)

(21) Appl. No.: 17/752,205

(22) Filed: May 24, 2022

(51) Int. Cl. H01M 10/0567; H01M 10/0569; H01M 4/505; H01M 4/525; H01M 50/431; H01M 10/0525

(52) U.S. Cl. CPC H01M 10/0567; H01M 10/0569; H01M 4/505; H01M 4/525; H01M 50/431; H01M 10/0525; H01M 2004/027

(57) ABSTRACT

A battery cell includes a cathode including a cathode active material; an anode including an anode active material; and an electrolyte including a non-aqueous polar solvent, a lithium salt, and a (R₃SiO)₃P(O), a (R₃SiO)₃P, or a mixture of any two or more thereof; wherein: R is C₁ to C₄ alkyl; the cathode active material has an areal density of at least 10 mg/cm² and a press density of at least 1.7 g/cc; the anode active material has an areal density of at least 5 mg/cm² and a press density of at least 1.3 g/cc; and the conductivity of the cathode and/or anode is increased compared to the same battery cell without the (R₃SiO)₃P(O), the (R₃SiO)₃P, or the mixture of any two or more thereof.

### INTRODUCTION

This disclosure generally is directed to electrolytes and their wetting ability for electrodes in lithium ion batteries. Specifically, the electrolytes incorporate tris(trimethylsilyl) phosphate (TMSPa), and related compounds, as additives to increase the wettability of the electrolyte towards the electrodes in lithium ion batteries of high energy density for electric vehicle applications.

### SUMMARY

A battery cell includes a cathode including a cathode active material; an anode including an anode active material; and an electrolyte including a non-aqueous polar solvent, a lithium salt, and a (R₃SiO)₃P(O), a (R₃SiO)₃P, or a mixture of any two or more thereof; wherein: R is C₁ to C₄ alkyl; the cathode active material has an areal density of at least 10 mg/cm² and a press density of at least 1.5 g/cc; the anode active material has an areal density of at least 5 mg/cm² and a press density of at least 1.3 g/cc; and the conductivity of the cathode and/or anode is increased compared to the same battery cell without the (R₃SiO)₃P(O), the (R₃SiO)₃P, or the mixture of any two or more thereof.

In another aspect, a method of preparing a lithium ion battery cell includes adding a (R₃SiO)₃P(O), a (R₃SiO)₃P, or a mixture of any two or more thereof to an electrolyte of a battery cell, wherein the battery cell exhibits stabilization of an open circuit voltage after filling of the electrolyte in less time as compared to a battery cell of the same composition where the electrolyte does not comprise (R₃SiO)₃P(O) and/or (R₃SiO)₃P, and wherein the electrolyte comprises a lithium salt and a non-aqueous polar solvent, and wherein R is a C₁-C₄ alkyl. In some embodiments, R is methyl or ethyl. In other embodiments, the (R₃SiO)₃P(O), the (R₃SiO)₃P, or the mixture of any two or more thereof is added to the electrolyte from greater than 0 wt % to about 2 wt %.

In a further aspect, a method of increasing the wettability of an electrolyte with regard to the cathode active and/or anode active materials in a lithium ion battery cell, the method comprising adding a (R₃SiO)₃P(O), a (R₃SiO)₃P, or a mixture of any two or more thereof to an electrolyte of a battery cell; wherein the battery cell comprises an cathode active material having an areal density of at least 10 mg/cm² and a press density of at least 1.5 g/cc; and an anode active material having an areal density of at least 5 mg/cm² and a press density of at least 1.3 g/cc. In some embodiments, the cathode active material is a lithium-rich cathode active material.

In other aspects, an electric vehicle including any of the battery cells described herein are provided.

### BRIEF DESCRIPTION OF THE DRAWINGS

FIG. 1 is a schematic illustration of how TMSPa may improve the wettability of an electrolyte, according to the examples.

FIGS. 2A and 2B are schematic side views of electrolyte droplets on the surface of an electrode, where the droplet contains no TMSPa (2A) and with TMSPa (2B), according to the examples.

FIGS. 3A and 3B are schematic top views of electrolyte droplets spreading on the surface of an electrode, where the droplet contains no TMSPa (2A) and with TMSPa (2B), according to the examples.

FIG. 4 is a graph of the open circuit voltage (OCV) of a lithium ion battery v. time after electrolyte filling, according to the examples.

FIGS. 5A and 5B are schematic illustrations of the cycling of an anode in an electrolyte with TMSPa (5A), and without TMSPa (5B), according to the examples.

FIG. 6 is an illustration of a cross-sectional view of an electric vehicle, according to various embodiments.

FIG. 7 is a depiction of an illustrative battery pack, according to various embodiments.

FIG. 8 is a depiction of an illustrative battery module, according to various embodiments.

FIGS. 9A, 9B, and 9C are cross sectional illustrations of various batteries, according to various embodiments.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

One of the major challenges encountered by lithium ion batteries in electric vehicle applications is to substantially increase the energy density. Increasing the areal active material loading of the electrodes and increasing their press density is a typical method to help achieve this goal. However, electrolyte wettability towards the electrodes and the mobility of the lithium ions can be subsequently undermined, leading to inferior power performance and detrimental lithium plating, particularly during low temperature operation.

It has now been found that compounds such as (O)P(OSiR₃)₃ and (O)P(OSiR₃)₃ improve the wettability of electrolytes toward thick and dense electrodes in high-energy density lithium ion batteries. Without being bound by theory, it is believed that such compounds improve the electrolyte wettability towards electrodes and facilitate the de-solvation of the lithium ions at the solid electrolyte interphase (“SEI”) in the anode and cathode electrolyte interphase (“CEI”) in the cathode of the cell through its interactions with the electrolyte solvent molecules that solvate the lithium ions. The compounds decrease the contact angle of the electrolytes on the surface of electrodes, thereby facilitating the spreading of the electrolytes on the surface. The compounds expedite open circuit voltage (“OCV”) stabilization after the electrolyte filling process. Further, the compounds reduce lithium plating in the lithium ion batteries.

In a first aspect, a battery cell is provided that includes a cathode comprising a cathode active material, an anode comprising an anode active material, and an electrolyte. The electrolyte includes a non-aqueous polar solvent, a lithium salt, and (R₃SiO)₃P(O), (R₃SiO)₃P, or a mixture of any two or more thereof, where R is C₁ to C₄ alkyl. As the loading level (mg/cm²) and packing density (g/cc) increase, (R₃SiO)₃P(O) and/or a (R₃SiO)₃P, present can enable or facilitate the dense electrode to become wetted by the liquid electrolyte. The overall effect provides for an increase in conductivity of the cathode and/or anode compared to the same battery cell without the (R3SiO)₃P(O), a (R₃SiO)₃P, or a mixture of any two or more thereof. In one example, the cathode active material exhibits an areal density in the range of 10-30 mg/cm² on a single side of a current collector and/or a press density in a range of 1.7-3.5 mg/cm² (e.g, after a calendaring or roll pressing of the electrode). In some embodiments, the cathode active material may be provided with an areal density of at least 15 mg/cm² and/or a press density of of at least 2.1 g/cm². In other embodiments, the cathode active material may be provided with an areal density of at least 20 mg/cm² and/or a press density of of at least 2.4 g/cm². In yet further embodiments, the anode active material exhibits an areal density in the range of 5-20 mg/cm² on a single side of a current collector and/or a press density in a range of 1.3-2.5 mg/cm² (e.g, after a calendaring or roll pressing of the electrode). In some embodiments, the anode active material may be provided with an areal density of at least 7 mg/cm² and/or a press density of of at least 1.5 g/cm². In some embodiments, cathode active material can be provided with an areal density of at least 8 mg/cm² and/or a press density of at least 1.6 g/cm².

In various embodiments, the cathode active material areal density is 10-30 mg/cm², and the press density is 1.7-3.5 mg/cm². In other embodiments, the anode active material areal density is 5-20 mg/cm², and the press density is 1.3-2.5 mg/cm². In some embodiments, the cathode active material areal density is 20-30 mg/cm², and the press density is 2.2-3.5 mg/cm². In other embodiments, the anode active material areal density is 8-20 mg/cm², and the press density is 1.5-2.5 mg/cm².

As used herein, the term “areal density” refers to the density at which the active material is packed in a given area (i.e. square centimeter). Higher density will provide higher capacity. Similarly, the “press density” refers to the density at which the active material is packed in a specified volume (i.e. cubic centimeter). Higher density will provide higher capacity.

In the battery cell, the (R₃SiO)₃P(O), (R₃SiO)₃P, or mixture of any two or more thereof may be present in the electrolyte from greater than 0 wt % to about 2 wt %. In some embodiments, this is from about 0.1 wt % to about 1.0 wt. %. In some embodiments, R is methyl or ethyl. In any of the above embodiments, the cell may include tris(trimethylsilyl)phosphate.

As noted above, the cells exhibit an increase in conductivity of the cathode and/or anode compared to the same battery cell without the (R₃SiO)₃P(O), (R₃SiO)₃P, or mixture of any two or more thereof In various embodiments, this increase is an amount from greater than 0 to about 1 mS/cm (milli Siemans per centimeter).

The electrolyte includes a non-aqueous polar solvent. Illustrative solvents include, but are not limited to, a carbonate such as ethylene carbonate, propylene carbonate, diethyl carbonate, ethyl methyl carbonate, dimethyl carbonate, or a mixture of any two or more thereof. The electrolytes may also include other additives such as, but not limited to, vinylidene carbonate, fluoroethylene carbonate, ethyl propionate, methyl propionate, methyl acetate, ethyl acetate, or a mixture of any two or more thereof. The lithium salt of the electrolyte may be any of those used in lithium ion battery construction including, but not limited to, lithium perchlorate, lithium hexafluorophosphate, lithium bis(fluorosulfonyl)imide, lithium bis(trifluorosulfonyl)imide, or a mixture of any two or more thereof. The salt may be present in the electrolyte from greater than 0 M to about 0.5 M.

As noted above, the present battery cells include dense electrodes in high-energy density lithium ion batteries. Illustrative cathode active materials include, but are not limited to, materials such as Li¹ₓM²₍ₓ₋₁₎PO₄, LiCoO₂, Li(NiₐMn_{b}Co_{c})O₂, Li(NiₐCo_{b}Al_{c})O₂, Li(Ni_{d}CoₑMn_{f}Al_{g})O₂, and Li(Mn_{α}Ni_{β})₂O₄, where M¹ and M² are each independently Fe, Mn, Co, or Ni; a+b+c=1, d+e+f+g=1 and α+β=1; and 0<x≤1. In some embodiments, the cathode active material includes LiFePO₄. In another embodiment, a Li-rich configuration may be used such as Li₁₊ₓM₁₋ₓO₂, where 0<x<0.4 and M=Ni, Mn, Co, and/or Al.

In any of the above embodiments, the battery cell may exhibit stabilization of an open circuit voltage after filling of the electrolyte in less time as compared to a battery cell of the same composition where the electrolyte does not comprise the (R₃SiO)₃P(O), (R₃SiO)₃P, or mixture of any two or more thereof.

In any of the above embodiments, the cell may further include a porous separator between the cathode and the anode, e.g. a porous polymer. The separator may further be coated with a metal oxyhydroxide a surface of the porous polymer. Illustrative metal oxyhydroxides include, but are not limited to, AlO(OH), MgO, SiO₂, and Al₂O₃.

The electrodes may include an active material and one or more of a current collector, a conductive carbon, a binder, and other additives. The electrodes may also contain other materials such as conductive carbon materials, current collectors, binders, and other additives. Illustrative conductive carbon species include graphite, carbon black, Super P carbon black material, Ketj en Black, Acetylene Black, single walled carbon nanotubes, multiwalled carbon nanotubes, graphite, carbon nanofiber, graphene, or a mixture of any two or more thereof.

Illustrative binders may include, but are not limited to, polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Other illustrative binder materials can include one or more of: agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrilic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

The current collector may include a metal that is aluminum, copper, nickel, titanium, stainless steel, or carbonaceous materials. In some embodiments, the metal of the current collector is in the form of a metal foil. In some specific embodiments, the current collector is an aluminum (Al) or copper (Cu) foil. In some embodiments, the current collector is a metal alloy, made of Al, Cu, Ni, Fe, Ti, or combination thereof In another embodiment, the metal foils maybe coated with carbon: e.g., carbon-coated Al foil and the like. The anodes of the electrochemical cells may include lithium. For examples, the anode may include lithium metal, lithium metal foil, and the like.

The battery cells described herein include lithium secondary battery cells.

In another aspect, provided herein are methods of preparing a lithium ion battery cell. The methods include adding a (R₃SiO)₃P(O), a (R₃SiO)₃P, or a mixture of any two or more thereof to an electrolyte of a battery cell, wherein the battery cell exhibits stabilization of an open circuit voltage after filling of the electrolyte in less time as compared to a battery cell of the same composition where the electrolyte does not comprise the (R₃SiO)₃P(O), the (R₃SiO)₃P, or the mixture of any two or more thereof, and wherein the electrolyte comprises a lithium salt and a non-aqueous polar solvent. In the formulas, as above, R may be a C₁-C₄ alkyl group. In some embodiments, R is methyl or ethyl. In other embodiments, the compound is tris(trimethylsilyl)phosphate.

In a further aspect, provided herein are methods of increasing the wettability of a battery cell. Such methods include filling a battery cell with an electrolyte that includes a (R₃SiO)₃P(O), a (R₃SiO)₃P, or a mixture of any two or more thereof, a cathode having a cathode active material, and an anode having an anode active material or a conductive carbon material. The battery cells of the methods exhibit improved wettability in comparison to a similarly constructed battery cell without the tris(trimethylsilyl)phosphate.

In another aspect, the present disclosure provides a battery pack comprising the cathode active material, the electrochemical cell, or the lithium ion battery of any one of the above embodiments. The battery pack may find a wide variety of applications including but are not limited to general energy storage or in vehicles. In another aspect, a plurality of battery cells as described above may be used to form a battery and/or a battery pack that may find a wide variety of applications such as general storage, or in vehicles.

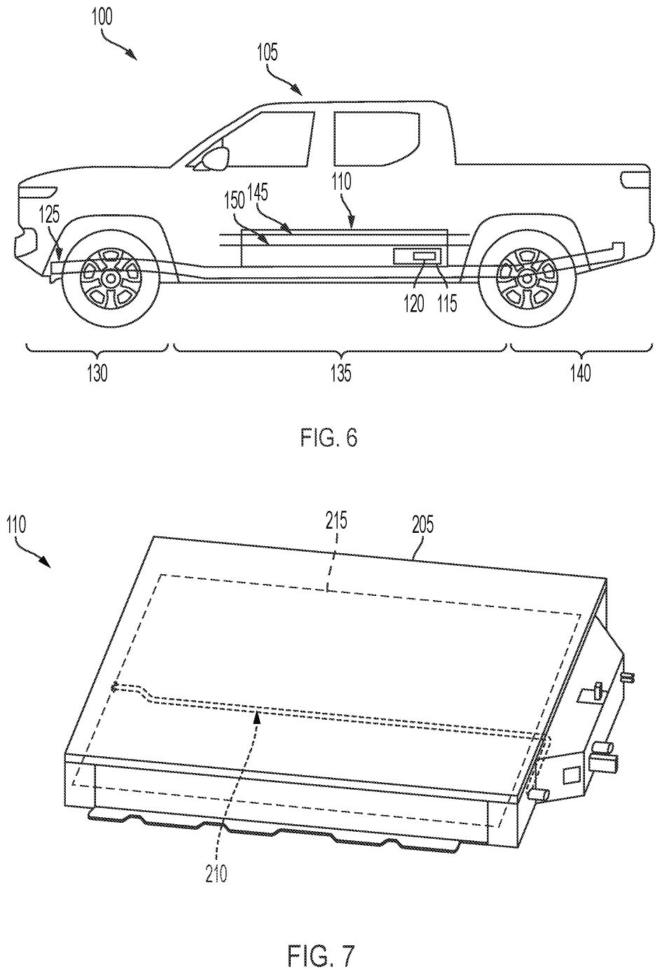

By way of illustration of the use of such batteries or battery packs in an electric vehicle, FIG. 6 depicts an illustrative cross-sectional view 100 of an electric vehicle 105 installed with at least one battery pack 110. Electric vehicle 105 may include an electric truck, electric sport utility vehicle (SUV), electric delivery van, electric automobile, electric car, electric motorcycle, electric scooter, electric passenger vehicle, electric passenger truck, electric commercial truck, hybrid vehicle, or other vehicle such as a sea or air transport vehicle, airplane, helicopter, submarine, boat, or drone, among other possibilities. The battery pack 110 may also be used as an energy storage system to power a building, such as a residential home, or commercial building. Electric vehicles 105 may be fully electric or partially electric (e.g., plug-in hybrid), and they may be fully autonomous, partially autonomous, or unmanned. Electric vehicles 105 can also be human operated or non-autonomous.

Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

FIG. 7 depicts an illustrative battery pack 110. Referring to FIG. 7, among others, the battery pack 110 may provide power to electric vehicle 105. Battery packs 110 may include any arrangement or network of electrical, electronic, mechanical, or electromechanical devices to power a vehicle of any type, such as the electric vehicle 105. The battery pack 110 may include at least one housing 205. The housing 205 may include at least one battery module 115 or at least one battery cell 120, as well as other battery pack components. The housing 205 may include a shield on the bottom or underneath the battery module 115 to protect the battery module 115 from external conditions, for example if the electric vehicle 105 is driven over rough terrain (e.g., off-road, trenches, rocks, etc.) The battery pack 110 may include at least one cooling line 210 that can distribute fluid through the battery pack 110 as part of a thermal/temperature control or heat exchange system that may also include at least one cold plate 215. The cold plate 215 may be positioned in relation to a top submodule and a bottom submodule, such as in between the top and bottom submodules, among other possibilities. The battery pack 110 may include any number of cold plates 215. For example, there may be one or more cold plates 215 per battery pack 110, or per battery module 115. At least one cooling line 210 may be coupled with, part of, or independent from the cold plate 215.

The housing 230 of the battery cell 120 may include one or more materials with various electrical conductivity or thermal conductivity, or a combination thereof. The electrically conductive and thermally conductive material for the housing 230 of the battery cell 120 may include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 may include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others.

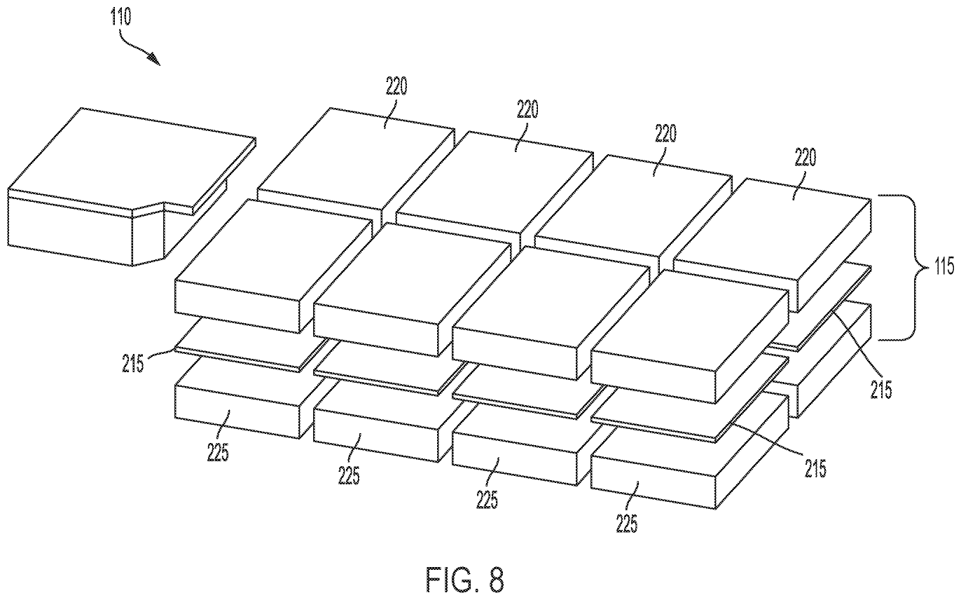

FIG. 8 depicts illustrative battery modules 115. The battery modules 115 may include at least one submodule. For example, the battery modules 115 may include at least one first (e.g., top) submodule 220 or at least one second (e.g., bottom) submodule 225. At least one cold plate 215 may be disposed between the top submodule 220 and the bottom submodule 225. For example, one cold plate 215 may be configured for heat exchange with one battery module 115. The cold plate 215 may be disposed within, or thermally coupled between, the top submodule 220 and the bottom submodule 225. One cold plate 215 may also be thermally coupled with more than one battery module 115 (or more than two submodules 220, 225). The battery submodules 220, 225 may collectively form one battery module 115. In some embodiments, each submodule 220, 225 may be considered as a complete battery module 115, rather than a submodule.

The battery modules 115 may each include a plurality of battery cells 120. The battery modules 115 may be disposed within the housing 205 of the battery pack 110. The battery modules 115 may include battery cells 120 that are cylindrical cells, prismatic cells, or other form factor cells. The battery module 115 may operate as a modular unit of battery cells 120. As an illustration, a battery module 115 may collect current or electrical power from the battery cells 120 that are included in the battery module 115 and may provide the current or electrical power as output from the battery pack 110. The battery pack 110 may include any number of battery modules 115. For example, the battery pack may have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a cold plate 215 between the top submodule 220 and the bottom submodule 225. The battery pack 110 may include, or define, a plurality of areas for positioning of the battery module 115. The battery modules 115 may be square, rectangular, circular, triangular, symmetrical, or asymmetrical. In some embodiments, battery modules 115 may be different shapes, such that some battery modules 115 are rectangular but other battery modules 115 are square shaped, among other possibilities. The battery module 115 may include or define a plurality of slots, holders, or containers for a plurality of battery cells 120.

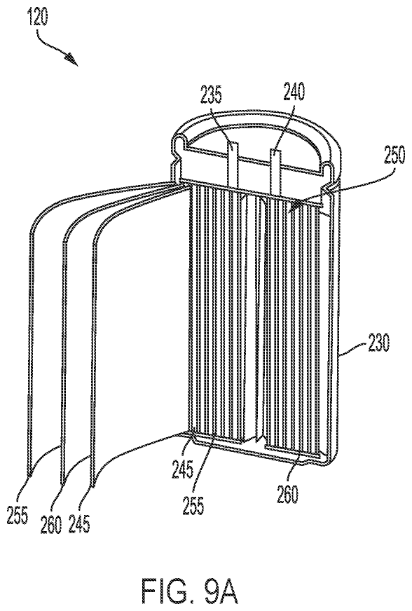

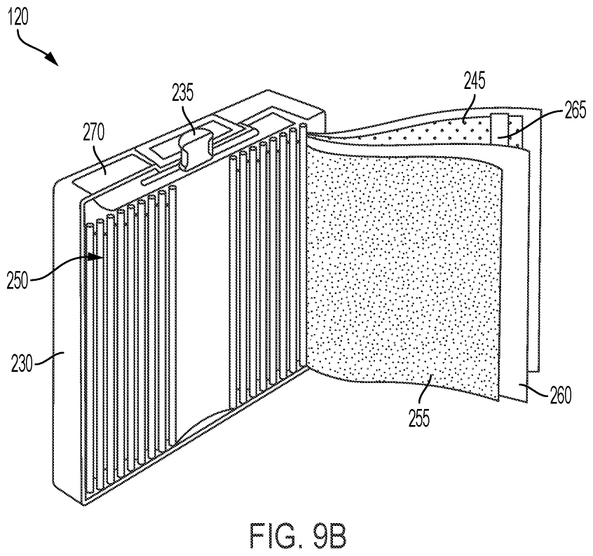

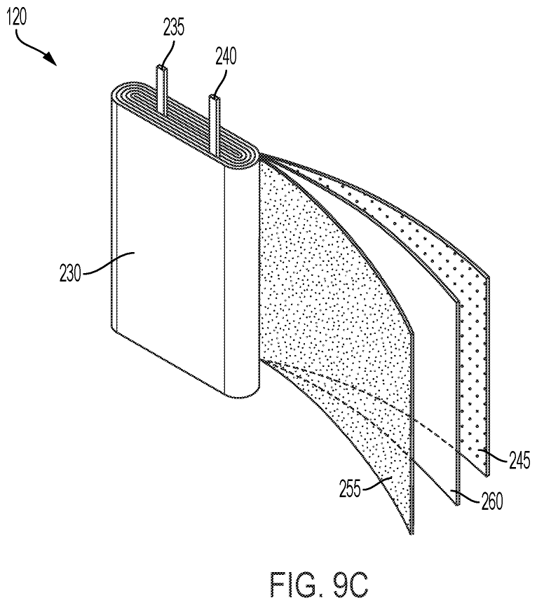

As noted above, battery cells 120 have a variety of form factors, shapes, or sizes. For example, battery cells 120 may have a cylindrical, rectangular, square, cubic, flat, or prismatic form factor. FIGS. 9A, 9B, and 9C depict illustrative cross sectional views of battery cells 120 in such various form factors. For example FIG. 9A is a cylindrical cell, 9B is a prismatic cell, and 9C is the cell for use in a pouch. The battery cells 120 may be assembled by inserting a wound or stacked electrode roll (e.g., a jellyroll) including electrolyte material into at least one battery cell housing 230. The electrolyte material, e.g., an ionically conductive fluid or other material, may generate or provide electric power for the battery cell 120. A first portion of the electrolyte material may have a first polarity, and a second portion of the electrolyte material may have a second polarity. The housing 230 may be of various shapes, including cylindrical or rectangular, for example. Electrical connections may be made between the electrolyte material and components of the battery cell 120. For example, electrical connections with at least some of the electrolyte material may be formed at two points or areas of the battery cell 120, for example to form a first polarity terminal 235 (e.g., a positive or anode terminal) and a second polarity terminal 240 (e.g., a negative or cathode terminal). The polarity terminals may be made from electrically conductive materials to carry electrical current from the battery cell 120 to an electrical load, such as a component or system of the electric vehicle 105.

The battery cell 120 may include at least one anode layer 245, which may be disposed within the cavity 250 defined by the housing 230. The anode layer 245 may receive electrical current into the battery cell 120 and output electrons during the operation of the battery cell 120 (e.g., charging or discharging of the battery cell 120). The anode layer 245 may include an active substance.

The battery cell 120 may include at least one cathode layer 255 (e.g., a composite cathode layer compound cathode layer, a compound cathode, a composite cathode, or a cathode). The cathode layer 255 may be disposed within the cavity 250. The cathode layer 255 may output electrical current out from the battery cell 120 and may receive electrons during the discharging of the battery cell 120. The cathode layer 255 may also release lithium ions during the discharging of the battery cell 120. Conversely, the cathode layer 255 may receive electrical current into the battery cell 120 and may output electrons during the charging of the battery cell 120. The cathode layer 255 may receive lithium ions during the charging of the battery cell 120.

The battery cell 120 may include an electrolyte layer 260 disposed within the cavity 250. The electrolyte layer 260 may be arranged between the anode layer 245 and the cathode layer 255 to separate the anode layer 245 and the cathode layer 255. The electrolyte layer 260 may transfer ions between the anode layer 245 and the cathode layer 255. The electrolyte layer 260 may transfer cations from the anode layer 245 to the cathode layer 255 during the operation of the battery cell 120. The electrolyte layer 260 may transfer cations (e.g., lithium ions) from the cathode layer 255 to the anode layer 245 during the operation of the battery cell 120.

FIG. 9B is an illustration of a prismatic battery cell 120. The prismatic battery cell 120 may have a housing 230 that defines a rigid enclosure. The housing 230 may have a polygonal base, such as a triangle, square, rectangle, pentagon, among others. For example, the housing 230 of the prismatic battery cell 120 may define a rectangular box. The prismatic battery cell 120 may include at least one anode layer 245, at least one cathode layer 255, and at least one electrolyte layer 260 disposed within the housing 230. The prismatic battery cell 120 may include a plurality of anode layers 245, cathode layers 255, and electrolyte layers 260. For example, the layers 245, 255, 260 may be stacked or in a form of a flattened spiral. The prismatic battery cell 120 may include an anode tab 265. The anode tab 265 may contact the anode layer 245 and facilitate energy transfer between the prismatic battery cell 120 and an external component. For example, the anode tab 265 may exit the housing 230 or electrically couple with a positive terminal 235 to transfer energy between the prismatic battery cell 120 and an external component.

The battery cell 120 may also include a pressure vent 270. The pressure vent 270 may be disposed in the housing 230. The pressure vent 270 may provide pressure relief to the battery cell 120 as pressure increases within the battery cell 120. For example, gases may build up within the housing 230 of the battery cell 120. The pressure vent 270 may provide a path for the gases to exit the housing 230 when the pressure within the battery cell 120 reaches a threshold.

The present invention, thus generally described, will be understood more readily by reference to the following examples, which are provided by way of illustration and are not intended to be limiting of the present invention.

### EXAMPLES

As illustrated in the structure of the compound, along with nine methyl groups, each tris(trimethylsilyl)phosphate (TMSPa) molecule possesses four oxygen atoms in the forms of P═O and P—O—Si, and each tris(trimethylsilyl)phosphite (TMSPi) molecule possesses three oxygen atoms in the forms of P—O—Si, any of which may serve as hydrogen bond acceptors, and.⁴ These hydrogen bond acceptors may form hydrogen bonds with hydroxyl and carboxylic acid functional groups that are typically present on the surface of lithium ion battery electrodes. The methyl groups assist in solvation, along with carbonate solvent molecules such as ethylene carbonate (EC), propylene carbonate (PC), ethyl methyl carbonate (EMC) and dimethyl carbonate (DMC), of lithium ions in the battery.

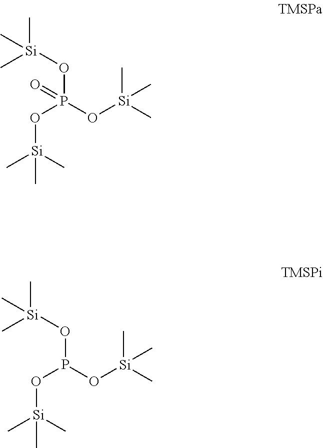

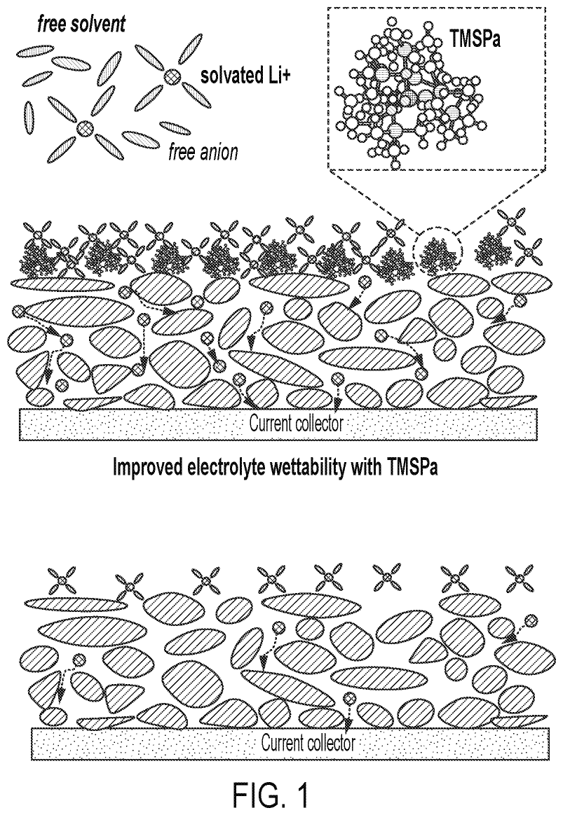

FIG. 1, is a schematic illustration of the solvation of lithium ions and how they may be attracted to the surface of the electrodes when TMSPa is present in the electrolyte as an additive. Because of the attraction between the TMSPa and the electrolyte solvent molecules (i.e. typically carbonates), the interaction between the solvated lithium ions and the electrolyte solvent molecules are weakened, and the lithium ions are more readily de-solvated and allowed to migrate through the solid/electrolyte interface (SEI) and into the bulk phase of the electrode.

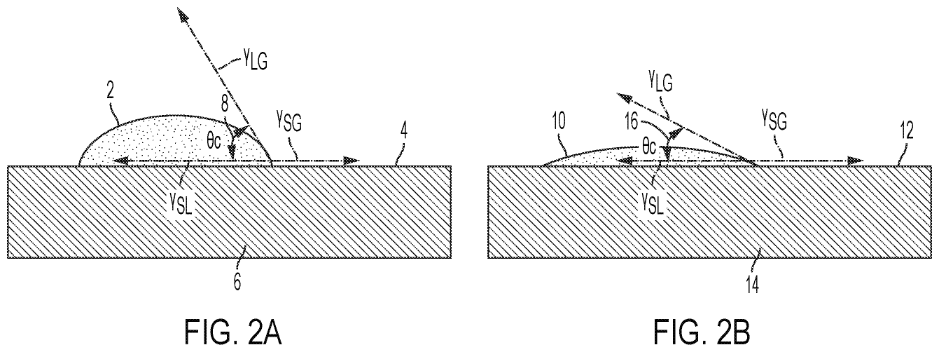

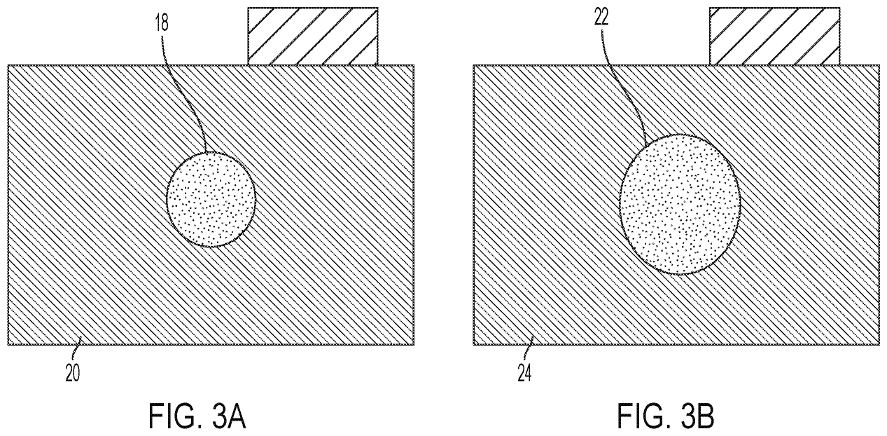

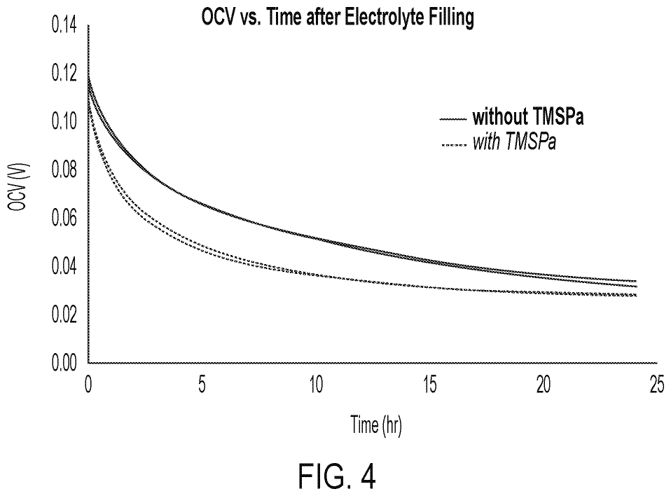

FIGS. 2A and 2B are schematic side views of electrolyte droplets 2,10 of the same volume without TMSPa (2A) and with TMSPa (2B) on the surfaces 4, 12 of the same electrode 6, 14. The angle of 8, 16 are the contact angle, θ_{c}, 8, 16 between the solid-liquid interfacial energy, γ_{SL}, and the liquid-gas interfacial energy, γ_{LG}. As depicted in FIG. 2, the contact angle of the electrolyte is substantially reduced with the addition of the TMSPa. Accordingly, as illustrated in FIGS. 3A and 3B, a schematic top view of a spreading of electrolyte droplets 18, 22 of the same volume on the surfaces 20, 24 of two identical electrodes over time, the electrolyte containing the TMSPa additive (3B) spreads noticeably faster on the surface of the electrode than the electrolyte without this additive (3A).

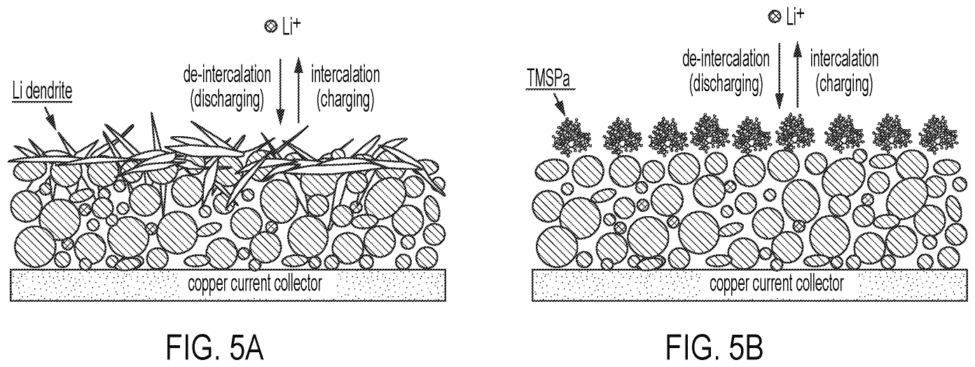

FIG. 5 is a graph of open circuit voltage v. time for an electrolyte with TMSPA and without TMSPa. As shown, there is a clear improvement of the wettability of an electrolyte by the TMSPa additive toward the electrode. The graph also shows that the electrolyte with the TMSPa stabilizing more rapidly compared to the non-TMSPa sample, over 24 hour monitoring following filling of the cell with the electrolyte (a mixture of ethylene carbonate, ethyl methylcarbonate, and dimethyl carbonate in a ratio of 30/45/25 on a volume basis, 1.0 M LiPF₆, vinylene carbonate (1 wt. %) and fluroethylene carbonate (1 wt. %) with and without TMSPa (0.5 wt. %)).

Without being bound by theory, it is believed that lithium plating caused by sluggish lithium migration may be mitigated through the use of improved wettability and lithium ion mobility using the TMSPa. FIGS. 5A and 5B are illustration of lithium plating during cycling using an electrolyte without the TMSPa additive (5A), and with the TMSPa additive (5B).

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can of course vary. It is also to be understood that the terminology used herein is for the purpose of describing particular embodiments only, and it is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A battery cell comprising:
a cathode comprising a cathode active material;
an anode comprising an anode active material; and
an electrolyte comprising a non-aqueous polar solvent, a lithium salt, and a (R₃SiO)₃P(O), a (R₃SiO)₃P, or a mixture of any two or more thereof
wherein:
R is C₁ to C₄ alkyl;
the cathode active material has an areal density of at least 10 mg/cm² and a press density of at least 1.7 g/cm²;
the anode active material has an areal density of at least 5 mg/cm² and a press density of at least 1.3 g/cm²; and
the conductivity of the cathode and/or anode is increased compared to the same battery cell without the (R₃SiO)₃P(O), the (R₃SiO)₃P, or the mixture of any two or more thereof

2. The battery cell of claim 1, wherein the (R₃SiO)₃P(O), the (R₃SiO)₃P, or the mixture of any two or more thereof is present in the electrolyte from greater than 0 wt % to about 2 wt %.

3. The battery cell of claim 1, wherein R is methyl or ethyl.

4. The battery cell of claim 1, wherein the increase in conductivity is from greater than 0 to about 1 mS/cm.

5. The battery cell of claim 1, wherein the cathode active material areal density is 10-30 mg/cm², and the press density is 1.7-3.5 mg/cm².

6. The battery cell of claim 1, wherein the anode active material areal density is 5-20 mg/cm², and the press density is 1.3-2.5 mg/cm².

7. The battery cell of claim 1, wherein the cathode active material areal density is 20-30 mg/cm², and the press density is 2.2-3.5 mg/cm².

8. The battery cell of claim 1, wherein the anode active material areal density is 8-20 mg/cm², and the press density is 1.5-2.5 mg/cm².

9. The battery cell of claim 1, wherein the non-aqueous polar solvent comprises a carbonate.

10. The battery cell of claim 1, wherein the lithium salt comprises lithium perchlorate, lithium hexafluorophosphate, lithium bis(fluorosulfonyl)imide, lithium bis(trifluorosulfonyl)imide, or a mixture of any two or more thereof

11. The battery cell of claim 1, wherein the lithium salt is present in the electrolyte from greater than 0 M to about 0.5 M.

12. The battery cell of claim 1, wherein the cathode active material comprises Li¹ₓM²₍ₓ₋₁₎PO₄, LiCoO₂, Li(NiₐMn_{b}Co_{c})O₂, Li(NiₐCo_{b}Al_{c})O₂, Li(Ni_{d}CoₑMn_{f}Al_{g})O₂, and Li(Mn_{α}Ni_{β})₂O₄, where M¹ and M² are each independently Fe, Mn, Co, or Ni; a+b+c=1, d+e+f+g=1 and α+β=1; and 0<x≤1.

13. The battery cell of claim 1, wherein the cathode active material comprises LiFePO₄.

14. The battery cell of claim 1, wherein the battery cell exhibits stabilization of an open circuit voltage after filling of the electrolyte in less time as compared to a battery cell of the same composition where the electrolyte does not comprise the (R₃SiO)₃P(O), a (R₃SiO)₃P, or a mixture of any two or more thereof.

15. The battery cell of claim 14, wherein the separator is a coated separator comprising a metal oxyhydroxide disposed on a surface of a porous polymer sheet.

16. The battery cell of claim 15, wherein the metal oxyhydroxide comprises AlO(OH), MgO, SiO₂, Al₂O₂..

17. A method of increasing the wettability of an electrolyte with regard to an electroactive material in a lithium ion battery, the method comprising:
adding a (R₃SiO)₃P(O), a (R₃SiO)₃P, or a mixture of any two or more thereof to an electrolyte of a lithium ion battery cell;
wherein:
the lithium ion battery cell comprises a cathode active material having an areal density of at least 10 mg/cm² and a press density of at least 1.7 g/cm²;
an anode active material having an areal density of at least 5 mg/cm² and a press density of at least 1.3 g/cm²; and
the lithium ion battery cell exhibits stabilization of an open circuit voltage after filling of the electrolyte in less time as compared to a battery cell of the same composition where the electrolyte does not comprise (R₃SiO)₃P(O), a (R₃SiO)₃P, or a mixture of any two or more thereof.

18. The method of claim 17, wherein the cathode active material is a lithium-rich cathode active material.

19. A method of preparing a lithium ion battery cell, the method comprising:
adding a (R₃SiO)₃P(O), a (R₃SiO)₃P, or a mixture of any two or more thereof to an electrolyte of a battery cell, wherein the battery cell exhibits stabilization of an open circuit voltage after filling of the electrolyte in less time as compared to a battery cell of the same composition where the electrolyte does not comprise (R₃SiO)₃P(O), a (R₃SiO)₃P, or a mixture of any two or more thereof, and wherein the electrolyte comprises a lithium salt and a non-aqueous polar solvent, and wherein R is a C₁-C₄ alkyl.

20. The method of claim 19, wherein the (R₃SiO)₃P(O), the (R₃SiO)₃P, or the mixture of any two or more thereof is added to the electrolyte from greater than 0 wt % to about 2 wt %.
